(19) United States
(12) Patent Application Publication
(10) Pub. No.: US 2014/0260857 A1
(43) Pub. Date: Sep. 18, 2014

(54) Rotary Strip Cutter

(71) Applicant: West Liberty Foods LLC, West Liberty, IA (US)

(72) Inventors: Edward Claussen, West Liberty, IA (US); Gerald Lessard, West Liberty, IA (US); Todd Bailey, West Liberty, IA (US)

(73) Assignee: West Liberty Foods LLC, West Liberty, IA (US)

(21) Appl. No.: 14/216,870

(22) Filed: Mar. 17, 2014

Related U.S. Application Data
(60) Provisional application No. 61/793,937, filed on Mar. 15, 2013.

(51) Int. Cl. B26D 7/32; B26D 7/06

(52) U.S. Cl. CPC B26D 7/32; B26D 7/0625
USPC 83/155

(57) ABSTRACT

The present invention relates to apparatus, systems and methods for manufacturing food, more specifically strip products out of meats such as chicken, of variable thickness and texture, in various shapes and sizes.

### CROSS-REFERENCE TO RELATED APPLICATION(S)

This application claims priority from U.S. Provisional Application 61/793,937, filed Mar. 15, 2013, and entitled “Rotary Strip Cutter” which is hereby incorporated herein by reference in its entirety.

### TECHNICAL FIELD

The present disclosure relates to apparatus, systems and methods for manufacturing food, more specifically strip products out of meats such as chicken, of variable thickness and texture, in various shapes and sizes.

### BACKGROUND

The present disclosure relates to apparatus, systems and methods of food processing, and more specifically to the field of portion cutting of food items, especially meat products, in pieces of predetermined shapes, such as quadratic pieces of meat.

Within the food production industry, there is demand for special cuts of meat, an example of these being special portion cuts of poultry such as chicken, particularly strips of generally uniform size, preferably pre-cooked, for ease of preparation for the consumer. As is well-known in the art, the such meat generally begins as de-boned leg and breast meat, where the remaining meat and skin are made “smooth” in one piece.

There is a need in the art for apparatus, systems and methods for high output production of food portions of specific dimensions.

### BRIEF SUMMARY

Disclosed herein is an apparatus for cutting a food product into strips, comprising: an in-feed skewing conveyor; a housing, further comprising a rotating head, wherein the rotating head cuts said product; and an out-feed conveyor. In certain embodiments, the food product is meat. In certain aspects, the rotating head cuts the product leaving an uncut margin. In further aspects, the uncut margin is between about 1/16″ and 1/64″ thick. In still further aspects, the uncut margin is about 1/32″ thick.

The disclosed system, apparatus and methods for cutting a meat product into strips, comprising: an in-feed skewing conveyor; a housing, further comprising a rotating head, wherein the rotating head cuts said product; and an out-feed conveyor further comprising a variable speed control configuration.

Certain exemplary embodiments of the disclosure comprise an apparatus for cutting a meat product into strips, comprising: an in-feed skewing conveyor; a housing, further comprising a rotating head, wherein the rotating head cuts said product; and an out-feed conveyor; wherein said in-feed skewing conveyer further comprises a plurality of belts or conveyance strips, said belts or conveyance strips running generally parallel to one another, and the belts or conveyance strips are driven by sprockets and the sprockets have a generally increasing diameter from one side of the in-feed skewing conveyer to the other, such that said belts or conveyance strips are driven at an generally increasing rate of speed from one side of the skewing conveyer to the other, such that product traveling over the belts or conveyance strips is rotated.

While multiple embodiments are disclosed, still other embodiments of the strip cutter will become apparent to those skilled in the art from the following detailed description, which shows and describes illustrative embodiments of the invention. As will be realized, the invention is capable of modifications in various obvious aspects, all without departing from the spirit and scope of the strip cutter. Accordingly, the drawings and detailed description are to be regarded as illustrative in nature and not restrictive.

### BRIEF DESCRIPTION OF THE DRAWINGS

FIG. 1 is a upper side view of the strip cutter according to an exemplary embodiment.

FIG. 2 is a perspective view of the strip cutter according to certain embodiments.

FIG. 3 is a detailed view of the strip cutter according to certain embodiments.

FIG. 4 is cross sectional side view of the strip cutter showing the rotary head according to certain embodiments.

FIG. 5 is a top view of a segment of the one of the plurality of conveyance strips of the skewing conveyer according to certain embodiments.

FIG. 6 is a cross sectional front view of the strip cutter belt frame according to certain exemplary embodiments.

FIG. 7 is a cross sectional front view of the drive sprockets according to certain embodiments.

FIG. 8 is contains various cross sectional view of the drive sprockets according to certain embodiments.

FIG. 9 is a side view of the out feed conveyer of the strip cutter according to certain implementations.

FIG. 10 is a detailed view of the inline width cutting member according to certain embodiments of the strip cutter.

FIG. 11 is a detailed view of the water fall flow and final product according to certain embodiments.

FIG. 12 is a detailed view of the strip cutter according to certain embodiments.

### DETAILED DESCRIPTION

The various systems, devices and methods disclosed herein relate to food processing. More specifically, various embodiments relate to processing meats such as chicken of variable thickness and texture into various shapes and sizes. Although the apparatus, system and methods have been described with reference to certain exemplary embodiments, persons skilled in the art will recognize that changes may be made in form and detail without departing from the spirit and scope of the apparatus, systems and methods. Similarly, for brevity, the disclosed apparatus, systems and methods will be referred to herein variously, but without limiting the disclosure to a singular aspect. Further, the term “strip cutter” shall be read as encompassing the assorted devices, systems and methods.

As used herein “product” or “meat product” means meat-like products, including but not limited to poultry, beef, pork, mutton, lamb, veal, and fish. Imitation meat products, that is products of vegetal origin but designed to replicate the texture, taste, and/or appearance of meat are also included within the meaning of “product” or “meat product” as used herein.

As best shown in FIG. 1, certain embodiments of the strip cutter 1 comprise an in-feed skewing conveyor 6, a housing 5 containing a rotary head (depicted in FIG. 4), and an out-feed conveyor 32. In exemplary embodiments, these are placed in sequence, such that a product 2 can be run through the strip cutter 1 in a substantially horizontal position for efficient processing. In certain embodiments, the product 2 can be spread across the strip cutter in a substantially sheet-like configuration. In various embodiments, this sheet can be approximately 40″ wide-though as one of skill in the art would readily recognize any number of other sizes are possible.

As would be apparent to one of skill in the art, the product 2 can be of any length on the intake because the strip cutter can run substantially continuously. Further, the speed of the various conveyers and other operative components of the strip cutter can be operated at a variety of speeds to maintain a consistent processing speed throughout the strip cutter. Exemplary embodiments of the strip cutter thus allow for a stream of product 2 to be fed into the housing 5 in-line with any upstream or downstream processing components while maintaining an even flow of product 2 through the strip cutter 1 for appropriate cooking and sizing.

A principle aspect of the strip cutter is in-line product rotation prior to product cutting (as is described in relation to FIG. 4). In various implementations, and as shown in FIGS. 2-3 & 12, the product 2 is fed into the strip cutter 1 from an upstream conveyer 4 onto an in-feed skewing conveyor 6. In certain embodiments, the product 2 is fed from other upstream line equipment (not shown), though this is not required. By way of example, in these embodiments, the product 2 undergoes processing by the upstream line equipment such that the product 2 fed onto to in-feed skewing conveyers 6 has already been cooked and/or order so as to be of a generally uniform thickness and texture. Further, in certain exemplary embodiments, upstream processing may create charring or “char” marks 8 on the product 2 with the char marks 8 in an orientation that generally parallel with direction of motion of the product through the strip cutter 1.

According to certain embodiments, as best seen in FIGS. 2 & 3, as the product 2 passes onto the in-feed skewing conveyor 6 from the upstream conveyer 4, the product 2 is rotated by the in-feed skewing conveyer 6, (as is further described in detail in relation to FIGS. 5-9). The rotation of the product 2 is such that char marks 8, previously parallel to the direction of movement, as depicted by reference letter B of the product 2, become angled with respect to the direction of movement (B), as is depicted by reference letter A. When the product 2 is subsequently cut (as is described in relation to FIG. 4), this rotation (A) yields a finished product that has the appearance of being cut on the bias with respect to the char marks 8.

FIG. 4 depicts an interior side-view of the strip cutter showing the rotary cutter 30 according to an exemplary embodiment. According to these embodiments, the product 2 is fed into the rotary cutter 30 by way of the in-feed skewing conveyor 6. In exemplary embodiments, the rotary cutter 30 functions to incise across the product 2 to within a very small margin of completely severing the product 2 (as is detailed further in relation to FIGS. 9-11), thus creating an uncut, or remaining margin. The remaining margin thus allows the strip cutter to retain the original configuration and/or orientation of the product 2 when passing onto the out feed conveyor 32, as best seen in FIG. 9. In certain embodiments, this remaining margin can be about 1/32″. In further embodiments, the uncut margin is between about ¼″ and about 1/16″. In still further embodiments, the uncut margin is between about 1/16″ and about 1/32″. In yet further embodiments, the uncut margin is between about 1/32″ and about 1/64″. One skilled in the art will appreciate that the desired thickness of the uncut margin will depend upon the characteristics of the product being cut.

In various embodiments, the in-feed skewing conveyor 6 further comprises a plurality of belts or conveyance strips or conveyance strips 14 running substantially parallel to one another. As best seen in FIGS. 5 & 6 & 12, each of the plurality of belts or conveyance strips 14 runs along one of a plurality of links 16 and is supported by plurality of braces 18.

As can be appreciated from FIGS. 7-8, the plurality of belts or conveyance strips 14 are driven by a plurality of drive sprockets 20. The plurality of drive sprockets 20 are driven by a drive shaft with the drive shaft being driven by a drive motor. Across the width of the in-feed skewing conveyer 6, the drive sockets 20 have a generally increasing diameter from the first side 20a of the skewing conveyor to the second side 20b such that the plurality of belts or conveyance strips generally increase in speed from the first side of the in-feed skewing 6a conveyer to the second side of the conveyer 6b.

As shown best in FIG. 9, another feature of certain embodiments is an out feed conveyor 32. In these embodiments, the out feed conveyor receives the product 2 that has been precut by the rotary head 30 thereby transferring the product to the next machine for further processing. According to certain embodiments, as best seen in FIG. 10, the out feed conveyer 32 moves product 2 to an inline width cutting member 34 that cuts the product 2 into strips at desired width. In still further embodiments, as best seen in FIG. 11, the product 2 once cut by the inline width cutting member 34, proceeds to an outflow which may according to certain embodiments, include a water fall type outflow feed 36. As the product 2 falls over the water fall outflow feed 36 the uncut margin breaks resulting in substantial separation of individual strips.

According to certain embodiments, another feature is a variable speed control configuration. According to certain embodiments, the variable speed control configuration serves to coordinate the speeds of the upstream processing feed, the inline skewing conveyer, and the downstream out feed conveyer. In these embodiments, variable speed controls, such as Alan-Bradley components, are in place to allow control of the in-feed conveyor, the rotary cutter and out feed conveyor speeds. The speed control is crucial for synchronizing the product flows to prevent jams in the product flow. For example, if jams or product backup are detected at the rotary head, upstream processing speeds can be slowed until the jams or backup are resolved.

According to certain embodiments, and as best seen in FIG. 11, the final cut product 40 is of a substantially uniform size. The substantially uniform product size produced by the apparatus and system disclosed herein allows more error free operation of downstream equipment. Further, greater uniformity of strip size results in fewer jams in downstream bagger sealing heads caused by irregularly sized final product, especially abnormally long product. Still further, the increased uniformity in the size of the finished product allows for the use of smaller bags and small boxes, the reduced the cost of packing and shipping the finished product.

Although the present invention has been described with reference to preferred embodiments, persons skilled in the art will recognize that changes may be made in form and detail without departing from the spirit and scope of the invention.

What is claimed is:

1. A strip cutter for a product, comprising:
a. an in-feed skewing conveyor configured to rotate the product to be cut;
b. a housing, further comprising a rotating head, wherein the rotating head cuts the product; and
c. an out-feed conveyor.

2. The strip cutter of claim 1, wherein the in-feed skewing conveyer further comprises a plurality conveyance strips oriented in a substantially parallel configuration.

3. The strip cutter of claim 2, wherein the substantially parallel conveyance strips are driven by a plurality of drive shafts, each drive shaft further comprising a plurality of drive sprockets in operational communication with the plurality of conveyance strips.

4. The strip cutter of claim 3, wherein the plurality of drive sprockets are of various diameter and oriented . . .

5. The apparatus of claim 1 wherein the rotating head cuts the product leaving an uncut margin.

6. The apparatus of claim 2 wherein the uncut margin is between about 1/16″ and 1/64″ thick.

7. The apparatus of claim 6 wherein the uncut margin is about 1/32″ thick.

8. The apparatus of claim 1 further comprising a variable speed control configuration.

9. The apparatus of claim 1 wherein the out-feed conveyor further comprises an inline width cutting member.

10. The apparatus of claim 2 further comprising a water fall-type feed, wherein the predetermined shape is such that the product breaks into individual pieces upon falling over the water fall-type feed.

11. The apparatus of claim 1 wherein said in-feed skewing conveyer further comprises a plurality of conveyance strips, said conveyance strips running generally parallel to one another.

12. The apparatus of claim 11 wherein said conveyance strips are driven by a plurality of sprockets.

13. The apparatus of claim 12 wherein the plurality of sprockets have a generally increasing diameter from one side of the in-feed skewing conveyer to the other such that said conveyance strips are driven at an generally increasing rate of speed from one side of the skewing conveyer to the other, such that product traveling over the conveyance strips is rotated.

14. The apparatus of claim 13, wherein the product to be cut has char marks.

15. The apparatus of claim 14, wherein the product is rotated with respect to the char marks such that the product appears cut on the bias when cut.

16. The apparatus of claim 14 wherein the rotation of the product to be cut is

17. The apparatus of claim 1 wherein said product to be cut is meat.

18. The apparatus of claim 17 wherein said meat to be cut is chicken.

19. The apparatus of claim 17 wherein the meat is cut into strips.

20. The apparatus of claim 19 wherein the strips are of a substantially uniform size.
